(19) United States
(12) Patent Application Publication
(10) Pub. No.: US 2005/0178879 A1
(43) Pub. Date: Aug. 18, 2005

(54) VTOL tailsitter flying wing

(76) Inventor: Youbin Mao, Pasadena, CA (US)

Correspondence Address: Youbin Mao, 430 N. Holliston Ave. #210, Pasadena, CA, 91106, US

(21) Appl. No.: 10/757,483

(22) Filed: Jan. 15, 2004

(51) Int. Cl. B64C 27/22

(52) U.S. Cl. 244/7 B

(57) ABSTRACT

A tail sitter VTOL vehicle with two pairs of propellers mounted respectively on left wing, right wing, top and bottom vertical tail stabilizers. The wing propellers and tail propellers spin in opposite directions. Full attitude control is realized in all flight phases through differential powering of the four propellers coordinated by electronic control system. Four propellers together generate sufficient thrust to counter gravity in hover mode, while the wings provide aerodynamic lift for efficient forward flight.

### FEDERALLY SPONSORED RESEARCH

Not Applicable

### SEQUENCE LISTING OR PROGRAM

Not Applicable

### BACKGROUND

1. Field of Invention

The present invention relates to a vertical takeoff and landing tail sitter aircraft capable of aerodynamically sustained horizontal flight.

### BACKGROUND

2. Descrption of Prior Art

VTOL capable aircraft can reach places and carry out missions that fixed wing aircraft can not. The most common example is a helicopter. But traditional helicopter design has many drawbacks: It is very inefficient and slow in forward flight, and its stability is maintained though complex mechanism that is heavy and unreliable. Thus helicopter is limited in its range and its ability to fly in adverse weather conditions.

Several designs have been attempted to acquire aerodynamically efficient forward flight like a fixed wing aircraft, while keeping VTOL capability. Tilt rotor, or tilt wing aircraft such as V-22 Osprey is one such example. Yet the complex mechanism to turn the rotors add lots of structural weight, and making stability control especially hard during transition between hover and forward flight.

Tail sitter is another VTOL design configuration tried many times before. Wernicke in U.S. Pat. No. 5,114,096 described a tail sitter airplane with a single propeller mounted to the nose section. However, it requires a multitude of control surfaces for stability and control in hover and forward flight—four airfoils in the tail section for aerodynamic control in forward flight, and four more airfoils in the forward section right behind the propeller to straighten the propeller slip-stream, as well as to maintain stability and control in hover mode. The attitude control is realized in hover by deflecting propeller slipstream. To be effective, the four forward control surfaces must be mounted as far away from the center of gravity as possible, requiring elongated fuselage that might not be structurally and aerodynamically efficient. Furthermore, the deflection of slipstream causes a coupling between angular and translational movements, inducing undesirable translational vibrations in hover mode. These problems are inherent to all existing tail sitter designs.

### OBJECTIVES AND ADVANTAGES

Therefore the objectives and advantages of the present invention are:
(a) to provide a VTOL tail sitter design that represents a better compromise between the conflicting requirements of vertical take off and forward flight.
(b) to provide a VTOL tail sitter design that is easy to control during all phases of flight, particularly during the transition between hover and forward flight which has been particularly challenging.
(c) to provide a VTOL tail sitter design that is mechanically simple with few moving parts or control surfaces, thus greatly improve reliability.
(d) to provide a VTOL tail sitter design that is highly agile and maneuverable, particularly suited for applications such as unmanned aerial vehicles in the battlefield.

Still further objects and advantages will become apparent from a consideration of the ensuing description and drawings.

### SUMMARY

In accordance with the present invention, a preferred embodiment includes a fuselage smoothly integrated with a pair of wings, a top and a bottom vertical stabilizer. Four propellers are mounted symmetrically in front of the wings on either side, and in front of the top and bottom vertical stabilizers respectively. The pair of wing propellers spin in one direction, while the pair of propellers mounted on the vertical stabilizers spin in the opposite direction.

The aircraft takes off and land vertically with its nose pointing up. Stability and attitude control is realized with differential thrust from the four propellers, either through variable propeller pitch angles, or variable rotational speed. In forward flight, the same control scheme could apply, with or without optional control surfaces.

### DRAWINGS

### BRIEF DESCRIPTION OF THE DRAWINGS

In the drawings, closely related figures have the same number but different alphabetic suffixes.

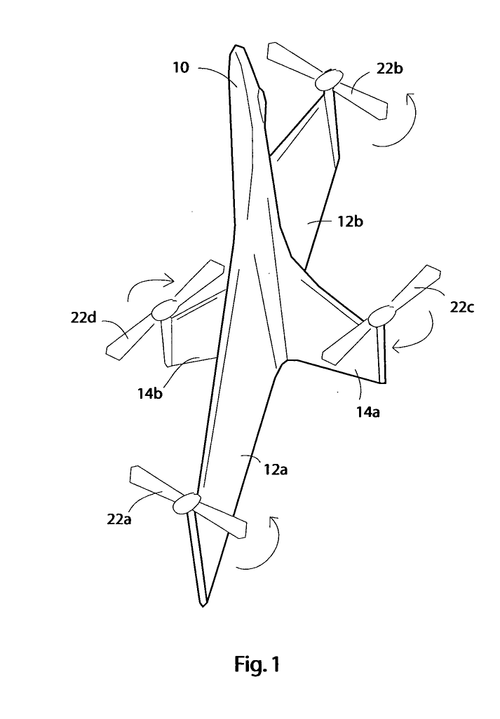

FIG. 1 shows a preferred embodiment of a VTOL tail sitter aircraft in hover mode in accordance with the present invention.

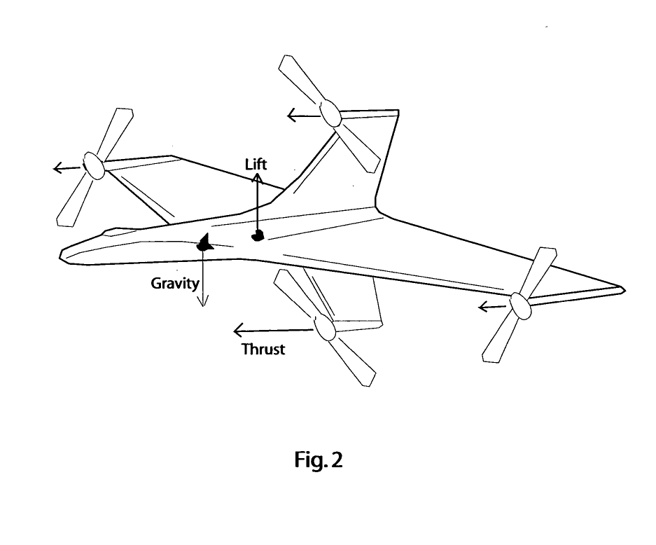

FIG. 2 illustrates a preferred embodiment of a VTOL tail sitter aircraft in horizontal flight, when the thrust from bottom propeller is higher than that from the top propeller to counter the pitch torque generated by gravity and aerodynamic lift.

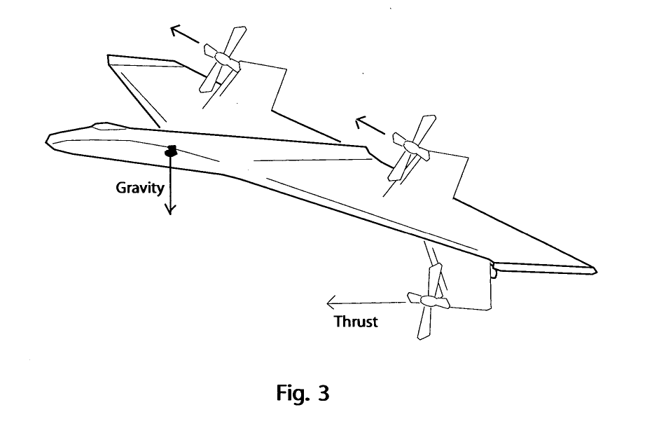

FIG. 3 illustrates an alternative embodiment of a VTOL tail sitter aircraft in accordance with the present invention. Two propellers on top of the wings point slightly upward, while the two propellers under the wings point slightly downward. In this figure, the bottom right propeller view is blocked by the right wing.

### REFERENCE NUMERALS IN DRAWINGS

10 fuselage
12a left wing
12b right wing
14a top vertical stabilizer
14b bottom vertical stabilizer
22a left propeller
22b right propeller
22c top propeller
22d bottom propeller

### DETAILED DESCRIPTION OF THE PREFERRED EMBODIMENT

Referring to FIG. 1, a VTOL tail sitter in the preferred embodiment of the present invention includes a fuselage 10 smoothly integrated with a pair of wings 12a and 12b; a top vertical stabilizer 14a, and a bottom vertical stabilizer 14b which are rigidly attached to the center tail section of the wings; four propellers 22a,22b,22c and 22d are installed in parallel to the center longitudinal axis of the fuselage, and positioned symmetrically in front of both wings, and in front of the top and bottom vertical stabilizers; Wing propellers 22a and 22b rotate clockwise, while propellers 22c and 22d rotate counterclockwise. The propellers are driven by a plurality of power plants with transmission means, with the thrust from each propeller independently controlled by onboard electronic control system, either through varying the pitch angles, or by changing rotational speeds.

In hover mode, the combined thrust from the four propellers counter the force of gravity, while the attitude stability and control is achieved with the differential thrusts from the four propellers: pitch control through differential thrusts between the top propeller 22c and bottom propeller 22d; roll control through differential thrusts between the left propeller 22a and right propeller 22b; while the yaw control is realized through differential thrusts between the wing propeller pair and the stabilizer propeller pair. It should be noted that with such attitude control strategy roll, pitch and yaw dynamics are completely decoupled; furthermore, angular and translational dynamics are decoupled as well.

In horizontal forward flight, attitude stability and control could be achieved with the same strategy as in hover mode. However, for efficient cruise, the top and bottom propellers can be stopped and folded up, if the wing airfoil is designed to be aerodynamically stable with S-shaped reverse camber near the trailing edges, so that the aircraft can be moved up and down through control of the combined thrust from the two wing propellers, while yaw control is effected with differential thrust from the left and right wing propellers. A slight dihedral angle is necessary to maintain roll stability.

Yet another strategy for efficient forward flight is illustrated in FIG. 2. If a more efficient wing airfoil with no reverse camber near tail section is chosen, then the pitch stability can be realized in forward flight by placing the center of gravity ahead of the center of lift of the wings, with the differential thrusts between the bottom and top propellers providing the counter torque.

It should be noted that optional control surfaces such as ailerons and rudders could be added to enhance attitude control in forward flight.

Advantages

From the description above, a number of advantages of the present invention become evident:
(a) The present invention provides an optimal compromise between the conflicting requirements of vertical takeoff and horizontal flight. While in hover mode, all four propellers generate thrust to counter gravity, in the forward flight mode, two propellers mounted on the top and bottom vertical stabilizers can be turned off and folded up, with the aircraft powered by the remaining pair of wing propellers for efficient cruise.
(b) The present invention provides a VTOL tail sitter design that is easy to control during all phases of flight. As a matter of fact, roll, pitch and yaw controls are completely decoupled; furthermore, angular and translational movements are also decoupled. Simple linear feedback controller would suffice.
(c) The present invention is mechanically very simple. Control surfaces and other moving parts are only optional. For example, if four fixed pitch propellers are each powered by a variable speed electric brushless motor, then the only moving parts are the motor rotors, ball bearings and propellers. Brushless motors themselves are very reliable and virtually maintenance free. UAVs of such design will become highly reliable and economical for mass production.
(d) The present invention provides a VTOL tail sitter design that is highly agile and maneuverable. Unlike previous designs that maintain relatively weak control through deflection of propeller slipstream, the differential thrusts of the four propellers in the present invention provides direct, fully decoupled, and fully saturated control. Even unconventional highly agile maneuvers will be attainable.

### Additional Embodiments

There are many additional embodiments that can demonstrate a variety of applications in accordance with the present invention.

A simple enhancement to the preferred embodiment adds peripheral ducts to the propellers to improve aerodynamic efficiency as well as safety.

It should be noted that a minimum of four propellers are required to realize full attitude control described in the current invention. There is no upper limit to the total number of independently controllable propellers according to current invention.

One alternative embodiment places a pair of propellers symmetrically above the left and right wings, and another pair of propellers below the two wings, all near the tail section of the aircraft. Refer to FIG. 3. Attitude control is realized with a similar strategy as for the preferred embodiment: Pitch control through differential thrusts between the top and bottom pairs of propellers; yaw control through differential thrusts of propeller pairs on left and right wings; roll control through differential thrusts of diagonal pairs of propellers. Furthermore, to increase effective pitch torque without extending the lengths of the vertical stabilizers that hold the prop engine pods, the top propeller pair can be installed at a slight angle upward from horizontal, while the bottom pair installed at a slight angle down from horizontal, as show in FIG. 3. As a matter of fact, the vertical stabilizers can be removed all together (though some simple landing gear mechanism might now become necessary): four pusher type propellers can be installed at up and down angles along the trailing edges of the wings, as long as they are at sufficient distances from the center of gravity. The advantage of such configuration is lighter structural weight, harder to be detected by radar and naked eyes, and in the case of UAV, easier to be folded up for transportation. For efficient forward flight, the top pair propellers can be turned off and folded up.

Yet further improvement can be made to the alternative embodiment above. Four propellers can be replaced with four ducted fans that have stators to straighten up slip streams. Because the top and bottom pairs are installed up and down from horizontal orientation respectively, roll control can still be realized with differential thrusts of the diagonal pairs. With the slip streams straightened by the stators, the ducted fan rotors can spin in the same direction, which not only reduce the number of different parts, but also can yield significant total angular momentum for gyroscopic stability that is particularly helpful in hover.

For piloted aircraft, or to provide a cockpit for payload instrument that must remain flat at all time, the nose section with the cockpit can be suspended with a pivot from the rest of the aircraft, so the nose section will always remain in horizontal position.

### Conclusion, Ramifications, and Scope

Thus it can be seen that the VTOL tail sitter of the present invention provides a simple, reliable, yet efficient and highly maneuverable design for many potential applications such as reconnaissance and attack, package delivery and aerial survey.

As demonstrated by the various alternative embodiments shown earlier, while my above description contains much specificity, these should not be construed as limitations on the scope of the invention, but rather as an exemplification of one preferred embodiment thereof.

Accordingly, the scope of the invention should be determined not by the embodiments illustrated, but by the appended claims and their legal equivalents.

1. A tail sitter aircraft, being capable of vertical take off and landing with its nose pointing up, and also being capable of horizontal flight with its nose pointing horizontally, comprising:
a pair of wings providing aerodynamic lift in a horizontal flight;
Four or more propellers, rigidly connected to said wings, whose center axes are in parallel to, or with only small offset angles from, said aircraft's longitudinal center axis, such that full three dimensional attitude control can be achieved with torques produced by varying thrusts from said propellers; each said propeller can generate independent streams of airflow for propelling and stabilizing said aircraft;
a plurality of power plants and transmission means for conveying the rotational energy from said power plants to the said propellers;
control means for coordinating the power generated by the power plants to maintain the balance and stability of said vehicle and to rotate and move said vehicle in any direction.

2. A VTOL vehicle as in claim 1 wherein some or all of said propellers can be folded back during horizontal forward flight.

3. A tail sitter aircraft, being capable of vertical take off and landing with its nose pointing up, and also being capable of horizontal flight with its nose pointing horizontally, comprising:
a pair of wings providing aerodynamic lift in a horizontal flight;
four propellers, rigidly connected to said wings, whose center axes are in parallel to, or with only small offset angles from, said aircraft's longitudinal center axis, such that full three dimensional attitude control can be achieved with torques produced by varying thrusts from said propellers; each said propeller can generate independent streams of airflow for propelling and stabilizing said aircraft;
a plurality of power plants and transmission means for conveying the rotational energy from said power plants to the said propellers;
control means for coordinating the power generated by the power plants to maintain the balance and stability of said vehicle and to rotate and move said vehicle in any direction.

4. A VTOL vehicle as in claim 3 wherein some or all of said propellers can be folded back during horizontal forward flight.
